(19) United States
(12) Patent Application Publication
(10) Pub. No.: US 2012/0026070 A1
(43) Pub. Date: Feb. 2, 2012

(54) PROJECTION DISPLAY APPARATUS

(75) Inventors: Azusa OZAKI, Sapporo-City (JP); Takahisa ANDO, Ikoma-City (JP); Shinya MATSUMOTO, Uji-City (JP); Makoto MAEDA, Nara-City (JP); Masafumi TANAKA, Hirakata-City (JP); Yoshinao HIRANUMA, Hirakata-City (JP)

(73) Assignee: SANYO Electric Co., Ltd., Moriguchi-City (JP)

(21) Appl. No.: 13/193,069

(22) Filed: Jul. 28, 2011

(30) Foreign Application Priority Data
Jul. 29, 2010 (JP) 2010-171212

(51) Int. Cl. G09G 5/00

(52) U.S. Cl. 345/1.3

(57) ABSTRACT

A projection display apparatus displays an image on a projection surface in cooperation with a second projection display apparatus. The projection display apparatus includes: a detection unit that detects the position of the second projection display apparatus; and a switching unit that performs switching between a stack display mode and a tile display mode on the basis of the position of the second projection display apparatus. In the stack display mode, an image projected by the projection display apparatus and an image projected by the second projection display apparatus are displayed on a projection surface in a stacked manner. In the tile display mode, an image projected by the projection display apparatus and an image projected by the second projection display apparatus are displayed on a projection surface in a side-by-side manner.

### CROSS REFERENCE TO RELATED APPLICATIONS

This application is based upon and claims the benefit of priority from prior Japanese Patent Application No. 2010-171212, filed on Jul. 29, 2010; the entire contents of which are incorporated herein by reference.

### BACKGROUND OF THE INVENTION

1. Field of the Invention

The present invention relates to a projection display apparatus that displays an image on a projection surface in cooperation with a second projection display apparatus.

2. Description of the Related Art

Conventionally, projection display apparatuses have been known which include an imager configured to modulate light emitted from a light source and a projection optical system configured to project the light exiting from the imager onto a projection surface.

Here, a technology has been proposed which enables a display system including multiple projection display apparatuses to superpose images respectively projected by the multiple projection display apparatuses on a projection surface (for example, Japanese Patent Application Publication No. Heisei 8-23502).

However, it is conceivable that if the multiple projection display apparatuses are in a certain positional relationship, the images respectively projected by the multiple projection display apparatuses cannot be superposed on each other on a projection surface. In other words, the above-described technology necessitates pre-adjustment of the positional relationship between the multiple projection display apparatuses.

### SUMMARY OF THE INVENTION

A projection display apparatus according to a first feature displays an image on a projection surface in cooperation with a second projection display apparatus. The projection image display apparatus includes: a detection unit (detection unit 320) that detects the position of the second projection display apparatus; and a switching unit (controller 330) that performs switching between a stack display mode and a tile display mode on the basis of the position of the second projection display apparatus. In the stack display mode, an image projected by the projection display apparatus and an image projected by the second projection display apparatus are displayed on the projection surface in a stacked manner. In the tile display mode, an image projected by the projection display apparatus and an image projected by the second projection display apparatus are displayed on the projection surface in a side-by-side manner.

In the first feature, the detection unit detects the position of the second projection display apparatus on the basis of an image obtained by capturing an image projected by the second projection display apparatus.

In the first feature, the projection display apparatus and the second projection display apparatus are capable of being connected to each other with a connection member. The detection unit detects the position of the second projection display apparatus on the basis of whether or not the projection display apparatus and the second projection display apparatus are connected to each other with the connection member.

In the first aspect, the projection display apparatus further includes an output unit (controller 330) that outputs assist information used to change a positional relationship between the projection display apparatus and the second projection display apparatus.

In the first aspect the projection display apparatus further includes a display unit (controller 330) that displays appended information in a region other than an overlap region of the image projected by the projection display apparatus and the image projected by the second projection display apparatus in the stack display mode, the appended information being appended to the image displayed in the overlap region.

### BRIEF DESCRIPTION OF THE DRAWINGS

FIG. 1 is a diagram showing a projection display apparatus 100 according to a first embodiment.

FIG. 2 is a diagram for describing an optical configuration of the projection display apparatus 100 according to the first embodiment.

FIG. 3 is a block diagram showing a control unit 300 according to the first embodiment. FIG. 4 is a diagram showing an example of detection of a second projection display apparatus 100 according to the first embodiment.

FIG. 5 is a diagram showing another example of detection of the second projection display apparatus 100 according to the first embodiment.

FIG. 6 is a diagram showing still another example of detection of the second projection display apparatus 100 according to the first embodiment.

FIG. 7 is a diagram showing an example of a stack display mode according to the first embodiment.

FIG. 8 is a diagram showing another example of the stack display mode according to the first embodiment.

FIG. 9 is a diagram showing still another example of the stack display mode according to the first embodiment.

FIG. 10 is a diagram showing an example of a tile display mode according to the first embodiment.

FIG. 11 is a flowchart showing operations of the control unit 300 according to the first embodiment.

FIG. 12 is a diagram showing a projection display apparatus 100 according to Modification 1.

FIG. 13 is a diagram showing an example of marks 430 according to Modification 1.

FIG. 14 is a diagram showing another example of marks 430 according to Modification 1.

FIG. 15 is a diagram showing an example of detection of a second projection display apparatus 100 according to Modification 2.

FIG. 16 is a diagram showing another example of detection of the second projection display apparatus 100 according to Modification 2.

FIG. 17 is a diagram showing an example of a stack display mode according to Modification 3.

FIG. 18 is a diagram showing an example of displaying appended information according to Modification 4.

FIG. 19 is a diagram showing another example of displaying appended information according to Modification 4.

### DETAILED DESCRIPTION OF THE EMBODIMENTS

A projection display apparatus according to embodiments of the present invention will be described below with reference to the accompanying drawings. In the following drawings, identical or similar constituents are denoted by identical or similar reference numerals.

It should be noted that the drawings are schematic and ratios of dimensions and the like are different from actual ones. Therefore, specific dimensions and the like should be determined in consideration of the following description. Moreover, the drawings also include portions having different dimensional relationships and ratios from each other.

### [Outline of Embodiments]

A projection display apparatus according to an embodiment displays an image on a projection surface in cooperation with a second projection display apparatus. The projection display apparatus includes: a detection unit that detects the position of the second projection display apparatus; and a switching unit that performs switching between a stack display mode and a tile display mode on the basis of the position of the second projection display apparatus. In the stack display mode, an image projected by the projection display apparatus and an image projected by the second projection display apparatus are displayed on a projection surface in a stacked manner. In the tile display mode, an image projected by the projection display apparatus and an image projected by the second projection display apparatus are displayed on a projection surface in a side-by-side manner.

In an embodiment, the detection unit detects the position of the second projection display apparatus, and the switching unit performs switching between the stack display mode and the tile display mode on the basis of the position of the second projection display apparatus. Accordingly, it is possible to appropriately display an image on a projection surface in cooperation with the second projection display apparatus without adjustment of the positional relationship with respect to the second projection display apparatus.

### First Embodiment

### (General Configuration of Projection Display Apparatus)

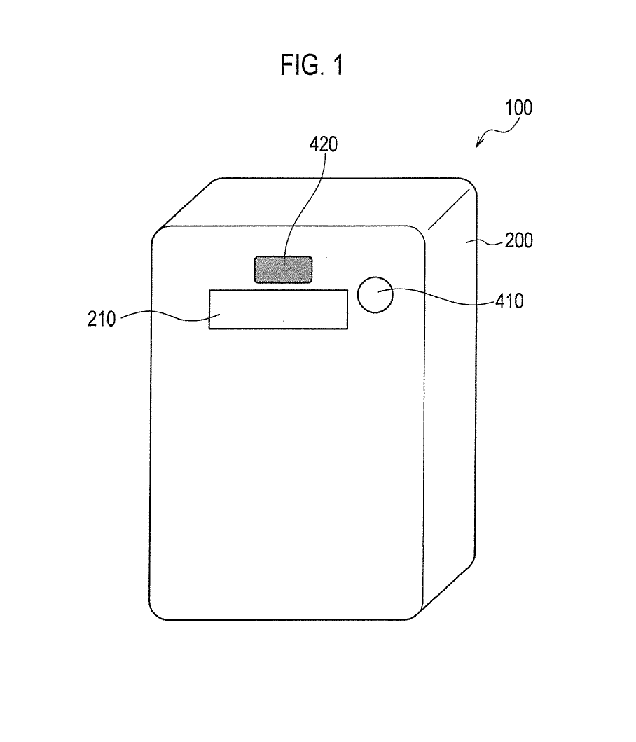

Hereinafter, a general configuration of a projection display apparatus according to a first embodiment will be described with reference to the drawings. FIG. 1 is a diagram showing a projection display apparatus 100 according to the first embodiment.

As shown in FIG. 1, the projection display apparatus 100 includes a case 200, and projects an image on a projection surface (unillustrated). The case 200 is provided with a transmission region 210 configured to transmit light exiting from a projection optical system 110 to be described later.

In addition, the projection display apparatus 100 include an image sensor 410 and a communication unit 420.

The image sensor 410 captures, for example, an image of the projection surface. The image sensor 410 is provided on, for example, one of the sidewalls of the case 200 on which the transmission region 210 is provided.

The communication unit 420 conducts wireless communication based on wireless LAN (for example, Bluetooth or IEEE 802.1 1a/b/g/n), IrDA, or the like with a second projection display apparatus 100. Note that the communication unit 420 may conduct wired communication with the second projection display apparatus 100.

Note that the size of the projection display apparatus 100 is approximately as large as a pet bottle having a capacity of 200 mL to 2 L. For example, the capacity of the projection display apparatus 100 is approximately 900 mL, and the weight of the projection display apparatus 100 is approximately 800 g. The size of an image displayed by the projection display apparatus 100 is, for example, approximately 20 inches. It should be noted that the distance between the projection display apparatus 100 and the projection surface is extremely short.

### (Optical Configuration of Projection Display Apparatus)

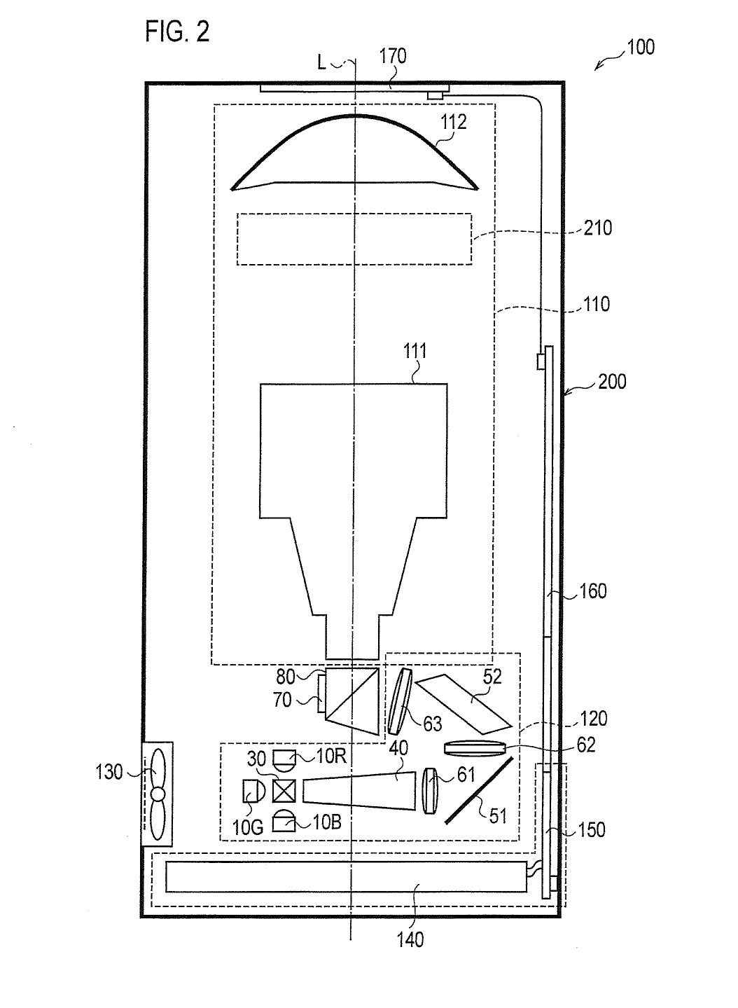

Hereinafter, an optical configuration of the projection display apparatus according to the first embodiment will be described with reference to the drawings. FIG. 2 is a diagram mainly showing an optical configuration of the projection display apparatus 100 according to the first embodiment.

As shown in FIG. 2, the projection display apparatus 100 includes the projection optical system 110, a lighting optical system 120, a cooling fan 130, a battery 140, a power supply board 150, a main control board 160, and an operation board 170. In addition, the projection display apparatus 100 includes a DMD 70 and a reflection prism 80.

The projection optical system 110 projects color component light (image light) exiting from the DMD 70 onto a projection surface. Specifically, the projection optical system 110 includes a projection lens group 111 and a reflection mirror 112.

The projection lens group 111 causes the color component light (image light) exiting from the DMD 70 to exit toward the reflection mirror 112. The projection lens group 111 includes lenses each having a substantially circular shape centered at an optical axis L of the projection optical system 110, lenses each having a shape constituted of a part of a substantially circular shape centered at the optical axis L of the projection optical system 110 (for example, a shape of a lower half of a circular shape), or the like.

It should be noted that the lenses included in the projection lens group 111 become larger in diameter, as the lenses approach the reflection mirror 112.

The reflection mirror 112 reflects color component light (image light) exiting from the projection lens group 111. The reflection mirror 112 concentrates the image light and converts the image light into wide-angle light. For example, the reflection mirror 112 is an aspherical mirror having a concave surface on the side of the projection lens group 111. Here, the reflection mirror 112 has a shape constituted of a part of a substantially circular shape centered at the optical axis L of the projection optical system 110 (for example, a shape of a lower half of a circular shape).

The image light condensed by the reflection mirror 112 is transmitted through the transmission region 210 provided on the case 200. The transmission region 210 provided on the case 200 is preferably located in the vicinity of a position where the image light is condensed by the reflection mirror 112.

The lighting optical system 120 includes a light source 10, a dichroic prism 30, a rod integrator 40, a mirror 51, a mirror 52, a lens 61, a lens 62, and a lens 63.

The light source 10 emits individual light components of multiple colors. Moreover, the light source 10 may be additionally provided with a heat sink configured to dissipate heat generated by the light source 10. Note that the light source 10 includes, for example, a light source 10R, a light source 10G, and a light source 10B.

The light source 10R is a light source configured to emit red component light R, and is a red LED (Light Emitting Diode) or a red LD (Laser Diode), for example. The light source 10R may be additionally provided with a heat sink constituted of a member having a high heat dissipation property, such as a metal member.

The light source 10G is a light source configured to emit green component light G, and is a green LED or a green LD, for example. The light source 10G may be additionally provided with a heat sink constituted of a member having a high heat dissipation property, such as a metal member.

The light source 10B is a light source configured to emit blue component light B, and is a blue LED or a blue LD, for example. The light source 10B may be additionally provided with a heat sink constituted of a member having a high heat dissipation property, such as a metal member.

The dichroic prism 30 synthesizes the red component light R emitted from the light source 10R, the green component light G emitted from the light source 10G, and the blue component light B emitted from the light source 10B.

The rod integrator 40 has a light incident surface, a light exit surface, and a light reflection side surface provided to extend from the circumference of the light incident surface to the circumference of the light exit surface. The rod integrator 40 converts the color component light exiting from the dichroic prism 30 into uniform light. Specifically, the rod integrator 40 converts the color component light into uniform light by reflecting the color component light on the light reflection side surface. Note that the rod integrator 40 may be a solid rod constituted of glass or the like, or a hollow rod whose inner surface is a mirror surface.

For example, in the first embodiment, the rod integrator 40 has such a tapered shape that the cross section thereof perpendicular to the traveling direction of the light emitted from the light source 10 becomes larger in the traveling direction of the light. Note, however, that embodiments are not limited thereto. The rod integrator 40 may have such an inverted tapered shape that the cross section thereof perpendicular to the traveling direction of the light emitted from the light source 10 becomes smaller in the traveling direction of the light.

The mirror 51 and the mirror 52 are reflection mirrors configured to deflect an optical path of the light exiting from the rod integrator 40 in order to guide the light to the DMD 70.

The lens 61, the lens 62, and the lens 63 are relay lenses configured to substantially form an image of the color component light emitted from the light source 10 on the DMD 70, while suppressing the spreading of the color component light.

The cooling fan 130 communicates with the outside of the case 200, and is configured to dissipate heat inside the case 200. Alternatively, the cooling fan 130 may be configured to introduce the air into the case 200 from the outside of the case 200. For example, the cooling fan 130 is provided in the vicinity of the light source 10, and configured to cool the light source 10.

The battery 140 stores power to be supplied to the projection display apparatus 100.

The power supply board 150 is connected to the battery 140, and has a power conversion circuit configured to convert AC power into DC power.

The main control board 160 includes a main control circuit (a control unit 300 to be described later) configured to control operations of the projection display apparatus 100.

The operation board 170 is connected to an operation unit (buttons and the like) provided to the projection display apparatus 100, and transmits operation signal inputted from the operation unit to the main control board 160 (the main control circuit).

The DMD 70 includes multiple micro mirrors, which are movable. Each of the micro mirrors basically corresponds to one pixel. The DMD 70 changes the angle of each of the micro mirrors to perform switching as to whether or not the color component light is reflected in order to guide the color component light toward the projection optical system 110 as effective light.

The reflection prism 80 transmits the light exiting from the lighting optical system 120 toward the DMD 70. Meanwhile, the reflection prism 80 reflects the light exiting from the DMD 70 toward the projection optical system 110.

### (Configuration of Control Unit)

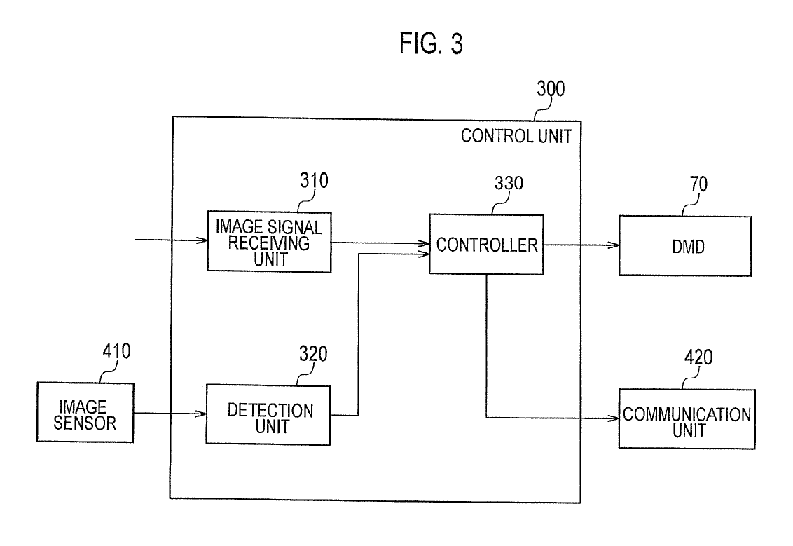

Hereinafter, a control unit according to the first embodiment will be described with reference to the drawings. FIG. 3 is a block diagram showing the control unit 300 according to the first embodiment. The control unit 300 is provided in the projection display apparatus 100, and controls the projection display apparatus 100.

Note that the control unit 300 converts image input signal into image output signal. The image input signal includes a red input signal Rᵢₙ, a green input signal Gᵢₙ, and a blue input signal Bᵢₙ. The image output signal includes a red output signal Rₒᵤₜ, a green output signal Gₒᵤₜ, and a blue output signal Bₒᵤₜ. The image input signal and the output signal are signal inputted for each of the multiple pixels constituting one frame.

As shown in FIG. 3, the control unit 300 includes an image signal receiving unit 310, a detection unit 320, and a controller 330.

The image signal receiving unit 310 receives image input signal from an external apparatus (unillustrated) such as a DVD player or a TV tuner.

The detection unit 320 detects the position of the second projection display apparatus 100. Specifically, the detection unit 320 is connected to the image sensor 410, and acquires an image captured by the image sensor 410.

Here, a case where a projection display apparatus 100B detects the position of a projection display apparatus 100A is taken as an example.

As shown in FIG. 4, the projection display apparatus 100A projects a pattern A in a first color onto a projection surface, whereas the projection display apparatus 100B projects a pattern B in a second color different from the first color onto the projection surface. In such a case, the detection unit 320 of the projection display apparatus 100B acquires an image obtained by capturing the pattern A and the pattern B from the image sensor 410, and detects the position of the projection display apparatus 100A on the basis of the color of a region where the pattern A and the pattern B overlap each other. It should be noted that the color of the overlap region is a mixture of the first color and the second color.

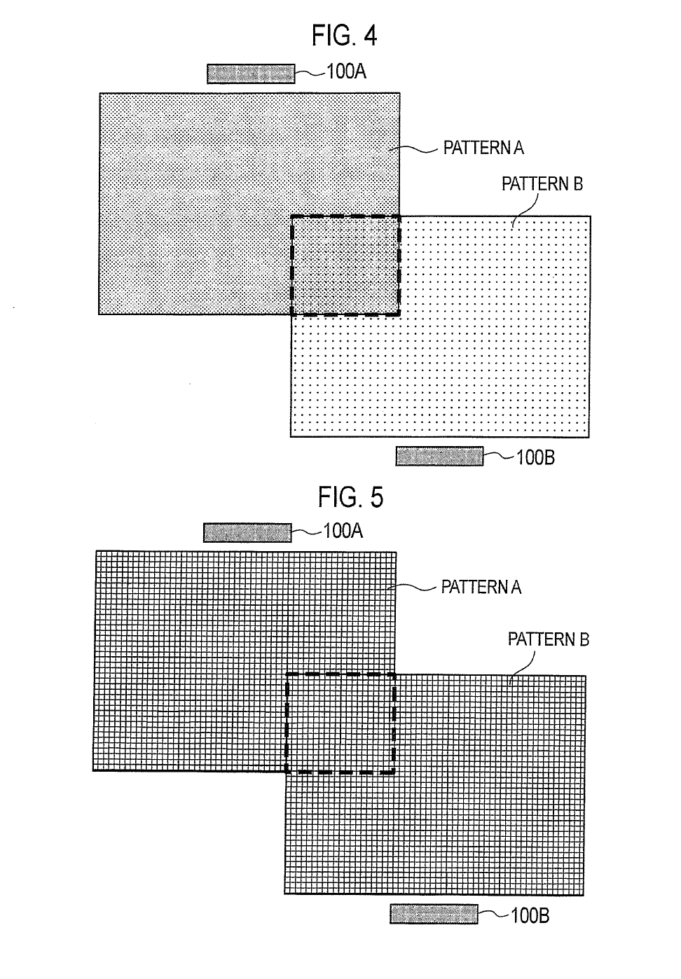

Alternatively, as shown in FIG. 5, the projection display apparatus 100A projects a grid pattern A onto a projection surface, whereas the projection display apparatus 100B projects another grid pattern B onto the projection surface. In such a case, the detection unit 320 of the projection display apparatus 100B acquires an image obtained by capturing the pattern A and the pattern B from the image sensor 410, and detects the position of the projection display apparatus 100A on the basis of the moiré pattern in the overlap region of the pattern A and the pattern B.

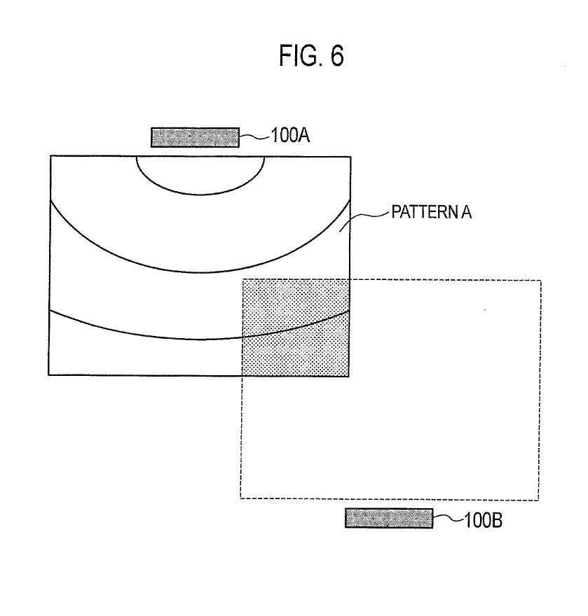

Alternatively, as shown in FIG. 6, the projection display apparatus 100A projects a pattern A including multiple wavefronts onto a projection surface. It should be noted that the normal lines of the multiple wavefronts in the pattern A pass through the projection display apparatus 100A. In such a case, the detection unit 320 of the projection display apparatus 100B acquires an image obtained by capturing the pattern A from the image sensor 410, and detects the position of the projection display apparatus 100A on the basis of the wavefronts included in the pattern A. Specifically, the detection unit 320 detects the position of the projection display apparatus 100A on the basis of the normal lines of the wavefronts and the spreading of the wavefronts.

With reference to FIG. 3 again, the controller 330 converts the image input signal into the image output signal, and controls the DMD 70 on the basis of the output signal. Moreover, the controller 330 controls the communication unit 420 such that the communication unit 420 communicates with the second projection display apparatus 100.

Here, the controller 330 performs switching between the stack display mode and the tile display mode on the basis of the position of the second projection display apparatus 100. In the stack display mode, an image projected by the projection display apparatus 100 (a first apparatus) and an image projected by the second projection display apparatus 100 are displayed on a projection surface in a stacked manner. On the other hand, in the tile display mode, an image projected by the projection display apparatus 100 (the first apparatus) and an image projected by the second projection display apparatus 100 are displayed on a projection surface in a side-by-side manner.

For example, the controller 330 selects the stack display mode, when the overlap region between a projectable range of the projection display apparatus 100 (the first apparatus) and a projectable range of the second projection display apparatus 100 is larger than a predetermined threshold (for example, 50% of a projectable range). On the other hand, the controller 330 selects the tile display mode, when the overlap region is not larger than the predetermined threshold.

Note that the controller 330 controls the DMD 70 such that the DMD 70 displays assist information used to change the positional relationship between the projection display apparatus 100 (the first apparatus) and the second projection display apparatus 100. For example, when the captured image does not contain the pattern projected by the second projection display apparatus 100, the controller 330 controls the DMD 70 such that the DMD 70 displays information notifying that the positional relationship between the projection display apparatuses 100 needs to be adjusted, as the assist information. Alternatively, the controller 330 controls the DMD 70 such that the DMD 70 displays information about the direction in which the projection display apparatus 100 (the first apparatus) or the second projection display apparatus 100 needs to be moved in order to employ the stack display mode, as the assist information. Alternatively, the controller 330 controls the DMD 70 such that the DMD 70 displays information about the direction in which the projection display apparatus 100 (the first apparatus) or the second projection display apparatus 100 needs to be moved in order to employ the tile display mode, as the assist information.

Hereinafter, a case is shown where the projection display apparatus 100A and the projection display apparatus 100B project an image on a projection surface in a cooperative manner.

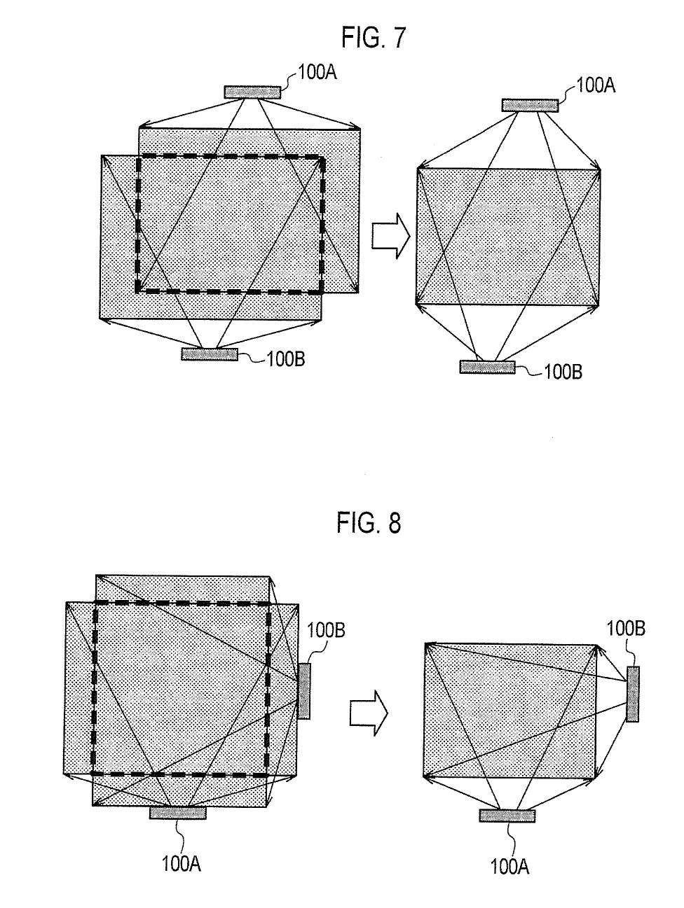

As shown in FIG. 7, when a direction in which the projection display apparatus 100A faces and a direction in which the projection display apparatus 100B faces are opposite to each other, and the overlap region is larger than the predetermined threshold, the image projected by the projection display apparatus 100A and the image projected by the projection display apparatus 100B are superposed on each other (the stack display mode).

As shown in FIG. 8, when a direction in which the projection display apparatus 100A faces and a direction in which the projection display apparatus 100B faces are perpendicular to each other, and the overlap region is larger than the predetermined threshold, the image projected by the projection display apparatus 100A and the image projected by the projection display apparatus 100B are superposed on each other (the stack display mode).

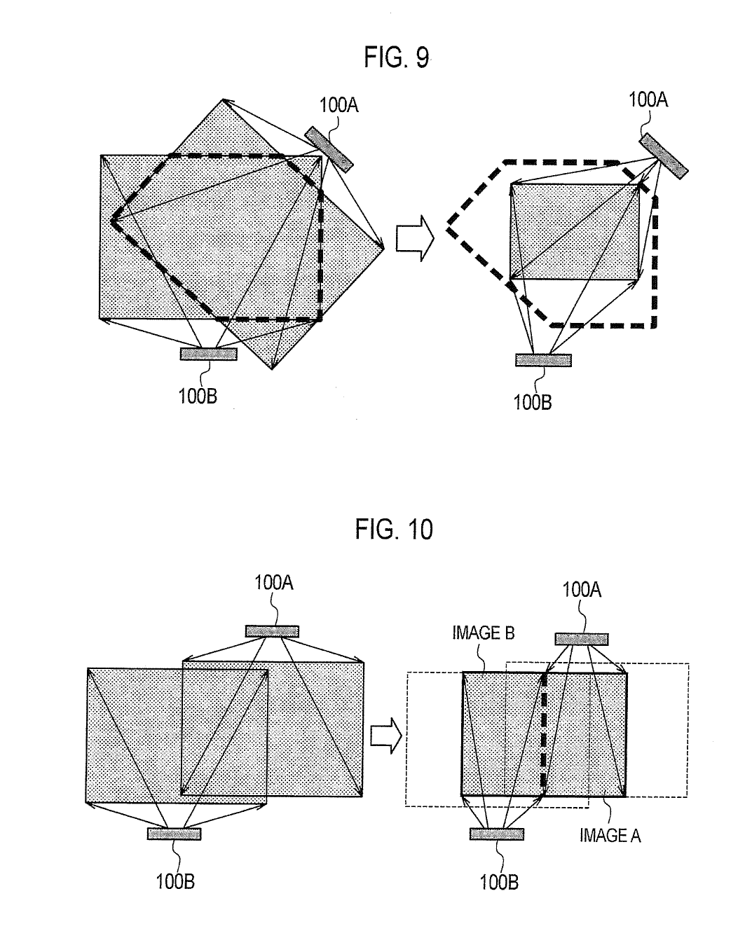

As shown in FIG. 9, when a direction in which the projection display apparatus 100A faces and a direction in which the projection display apparatus 100B faces cross each other obliquely, and the overlap region is larger than the predetermined threshold, the image projected by the projection display apparatus 100A and the image projected by the projection display apparatus 100B are superposed on each other (the stack display mode). Note that, in the case shown in FIG. 9, the images are superposed on each other in a quadrangular region having a predetermined aspect ratio within the overlap region. Note that the quadrangular region having the predetermined aspect ratio is preferably set as large as possible within the overlap region.

As shown in FIG. 10, when a direction in which the projection display apparatus 100A faces and a direction in which the projection display apparatus 100B faces are opposite to each other, and the overlap region is not larger than the predetermined threshold, the image projected by the projection display apparatus 100A and the image projected by the projection display apparatus 100B are arranged in a side-by-side manner (the tile display mode).

### (Operations of Control Unit)

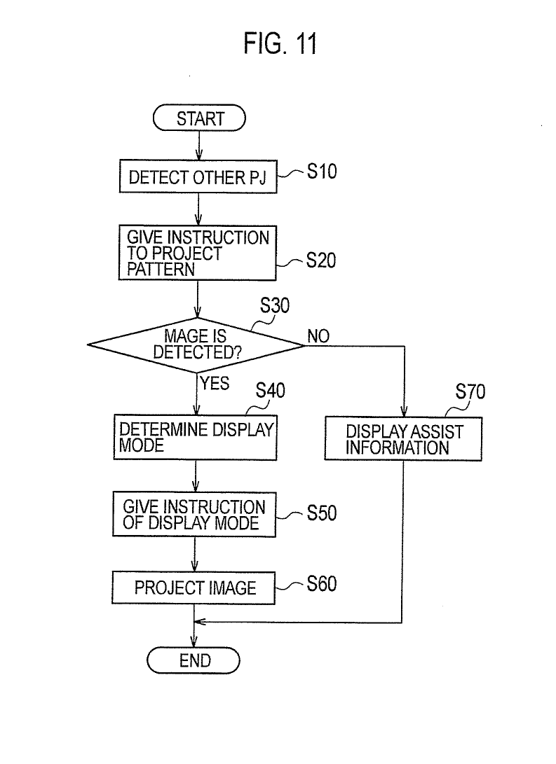

Hereinafter, operations of the control unit according to the first embodiment will be described with reference to the drawings. FIG. 11 is a flowchart showing operations of the control unit 300 according to the first embodiment.

As shown in FIG. 11, the control unit 300 detects the second projection display apparatus 100 in Step 10. For example, the control unit 300 detects the second projection display apparatus 100 by transmitting searching packets on the basis of wireless communication technology, for example.

In Step 20, the control unit 300 instructs the second projection display apparatus 100 to project the patterns exemplified in FIGS. 4 to 6. In Step 30, the control unit 300 determines whether or not an image (pattern) projected by the second projection display apparatus 100 is detected on the basis of an image captured by the image sensor 410. When the image (pattern) is detected, the control unit 300 proceeds to a process in Step 40. When the image (pattern) is not detected, the control unit 300 proceeds to a process in Step 70.

In Step 40, the control unit 300 determines (selects) a display mode to be employed from the stack display mode and the tile display mode.

In Step 50, the control unit 300 instructs the second projection display apparatus 100 to employ the display mode determined (selected) in Step 40.

In Step 60, the control unit 300 projects an image on a projection surface in accordance with the display mode determined (selected) in Step 40.

In Step 70, the control unit 300 projects assist information used to change the positional relationship between the projection display apparatus 100 and the second projection display apparatus 100 onto the projection surface.

### (Operations and Effects)

In the first embodiment, the detection unit 320 detects the position of the second projection display apparatus 100, and the controller 330 performs switching between the stack display mode and the tile display mode on the basis of the position of the second projection display apparatus 100. Accordingly, it is possible to appropriately display an image on a projection surface in cooperation with the second projection display apparatus 100, without adjustment of the positional relationship with respect to the second projection display apparatus 100.

### Modification 1

Hereinafter, Modification 1 of the first embodiment will be described. In the following description, differences from the first embodiment will mainly be described. Specifically, in the first embodiment, the detection unit 320 detects the position of the second projection display apparatus 100 on the basis of the image obtained by capturing an image projected by the second projection display apparatus 100. In contrast, in Modification 1, the detection unit 320 detects the position of the second projection display apparatus 100 on the basis of a mark provided to the second projection display apparatus 100.

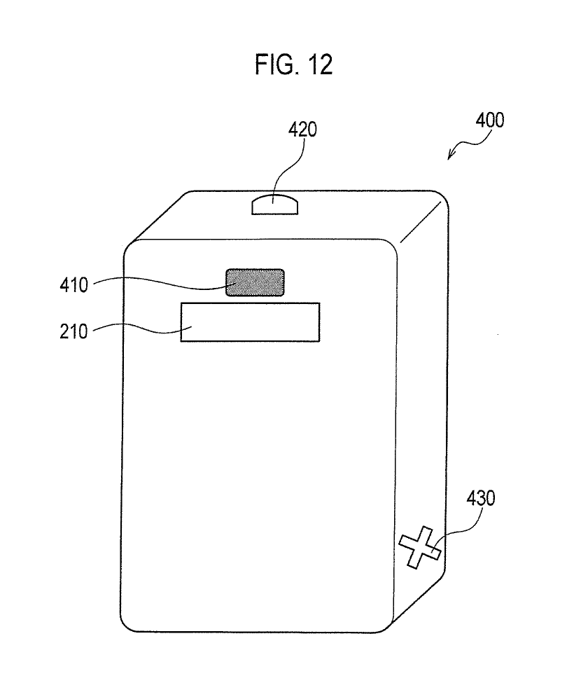

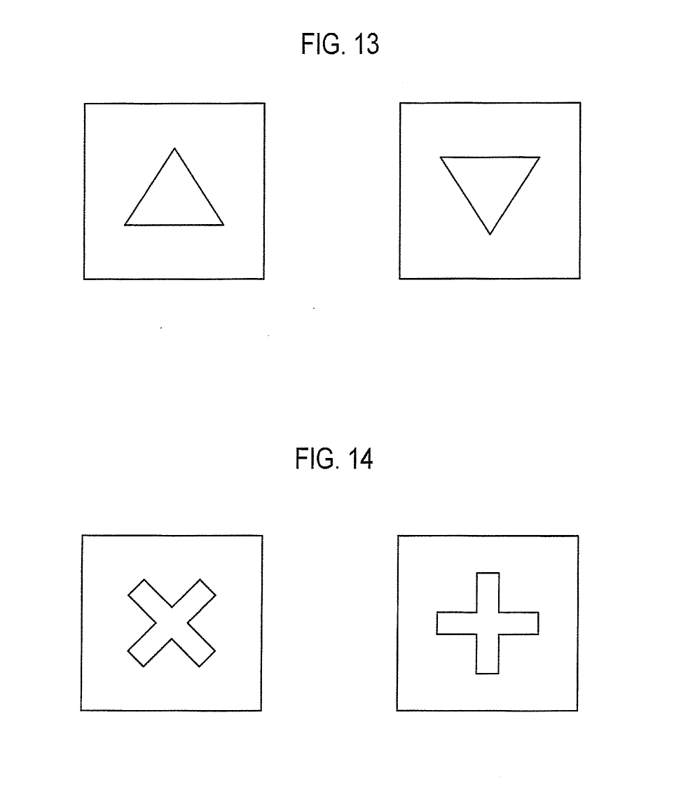

For example, as shown in FIG. 12, the second projection display apparatus 100 has a mark 430 provided on a sidewall of the case 200. Note that it is preferable to provide marks 430 in two positions (for example, on left and right sidewalls) of the case 200 so that the direction in which the second projection display apparatus 100 faces can be detected. For example, it is preferable to provide different kinds of marks 430 in two positions of the case 200 as shown in FIGS. 13 and 14.

### Modification 2

Hereinafter, Modification 2 of the first embodiment will be described. In the following description, differences from the first embodiment will mainly be described.

Specifically, in the first embodiment, the detection unit 320 detects the position of the second projection display apparatus 100 on the basis of an image obtained by capturing the image projected by the second projection display apparatus 100. In contrast, in Modification 2, the detection unit 320 detects the position of the second projection display apparatus 100 on the basis of whether or not the projection display apparatus 100 and the second projection display apparatus 100 are connected to each other with a connection member (cradles).

For example, description is given of a case where the projection display apparatus 100A is mounted on a cradle 500A, and the projection display apparatus 100B is mounted on a cradle 500B.

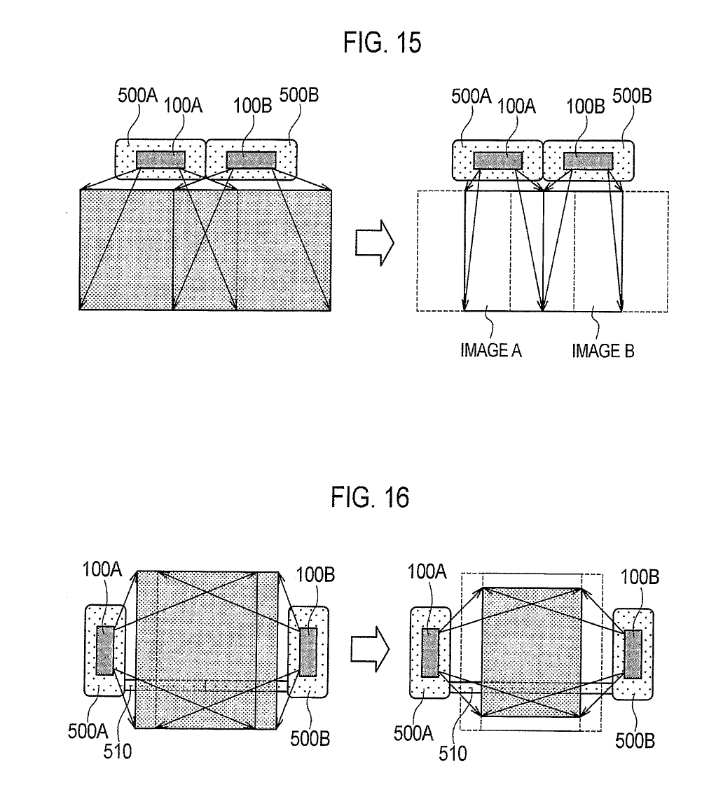

In such a case, the tile display mode is employed, when the cradle 500A and the cradle 500B are directly connected to each other as shown in FIG. 15. On the other hand, the stack display mode is employed, when the cradle 500A and the cradle 500B are connected to each other with a connection arm 510 as shown in FIG. 16.

Note that the cases shown in FIGS. 15 and FIG. 16 are mere examples. Depending on the shapes of the cradle 500A and the cradle 500B, the stack display mode may be employed when the cradle 500A and the cradle 500B are directly connected to each other. Likewise, depending on the shape of the connection arm 510, the tile display mode may be employed when the cradle 500A and the cradle 500B are connected to each other with the connection arm 510.

### Modification 3

Hereinafter, Modification 3 of the first embodiment will be described. In the following description, differences from the first embodiment will mainly be described.

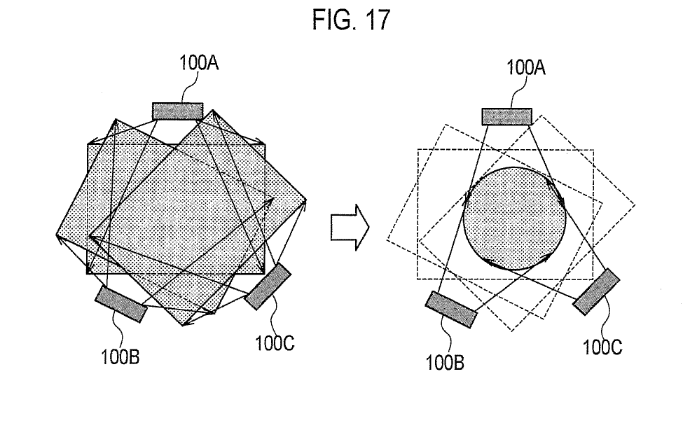

Specifically, in the first embodiment, the images are displayed in the stack display mode in such a manner as to be superposed on each other in a quadrangular region having a predetermined aspect ratio within an overlap region of projectable ranges of the multiple projection display apparatuses 100. In contrast, in Modification 3, the images are superposed on each other in a circular region within an overlap region of projectable ranges of multiple projection display apparatuses 100 (projection display apparatuses 100A to 100C) as shown in FIG. 17.

In this way, the images may be superposed on each other in a region having any shape. Moreover, any number of projection display apparatuses 100 may be used in cooperation.

### Modification 4

Hereinafter, Modification 4 of the first embodiment will be described. In the following description, differences from the first embodiment will mainly be described.

In Modification 4, appended information is displayed in a region which is within the projectable range, and which is other than the region where the image is displayed. Note that the appended information may be information used for interactive operations (for example, drawing toolbar), information for guide to a region where characters can be inputted, information used for a video conference (for example, an image on your end or the other end), information about various menus, a sub screen, subtitles, the previous image slide of a material, information about operational instruction of the projection display apparatus 100, results of speech recognition, alarm information of the projection display apparatus 100, data broadcasting, news, date and time information, a calendar, time of image viewing, or the like.

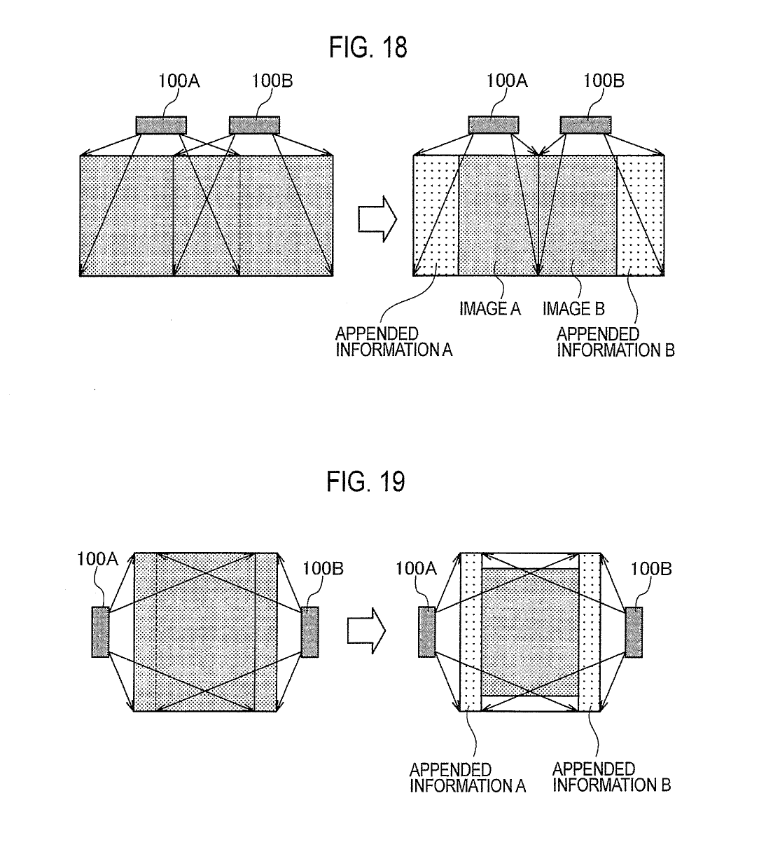

Specifically, as shown in FIG. 18, the projection display apparatus 100A displays an image A and also appended information A within the projectable range of the projection display apparatus 100A in the tile display mode. Likewise, the projection display apparatus 100B displays an image B and also appended information B within the projectable range of the projection display apparatus 100B. It should be noted that the image A and the image B are arranged in a side-by-side manner to constitute a single image.

Alternatively, as shown in FIG. 19, the projection display apparatus 100A displays an image A and also appended information A within a projectable range of the projection display apparatus 100A in the stack display mode. Likewise, the projection display apparatus 100B displays an image B and also appended information B within the projectable range of the projection display apparatus 100B. It should be noted that the image A and the image B are superposed on each other to constitute a single image.

### OTHER EMBODIMENTS

As described above, the details of the present invention have been disclosed by using the embodiments of the present invention. However, it should not be understood that the description and drawings which constitute part of this disclosure limit the present invention. From this disclosure, various alternative embodiments, examples, and operation techniques will be easily found by those skilled in the art.

In the embodiments, the DMD (Digital Micromirror Device) is shown as a mere example of the imager. The imager may be a liquid crystal panel of a reflection type, or a liquid crystal panel of a transmission type.

In the embodiments, the assist information is projected (displayed) on the projection surface. However, embodiments are not limited thereto. The assist information may be outputted as a voice or the like.

What is claimed is:

1. A projection display apparatus that displays an image on a projection surface in cooperation with a second projection display apparatus, the projection display apparatus comprising:
a detection unit that detects the position of the second projection display apparatus; and
a switching unit that performs switching between a stack display mode and a tile display mode on the basis of the position of the second projection display apparatus, wherein
in the stack display mode, an image projected by the projection display apparatus and an image projected by the second projection display apparatus are displayed on the projection surface in a stacked manner, and
in the tile display mode, an image projected by the projection display apparatus and an image projected by the second projection display apparatus are displayed on the projection surface in a side-by-side manner.

2. The projection display apparatus according to claim 1, wherein
the detection unit detects the position of the second projection display apparatus on the basis of an image obtained by capturing an image projected by the second projection display apparatus.

3. The projection display apparatus according to claim 1, wherein
the projection display apparatus and the second projection display apparatus are capable of being connected to each other with a connection member, and
the detection unit detects the position of the second projection display apparatus on the basis of whether or not the projection display apparatus and the second projection display apparatus are connected to each other with the connection member.

4. The projection display apparatus according to claim 1, further comprising an output unit that outputs assist information used to change a positional relationship between the projection display apparatus and the second projection display apparatus.

5. The projection display apparatus according to claim 1, further comprising a display unit that displays appended information in a region other than an overlap region of the image projected by the projection display apparatus and the image projected by the second projection display apparatus in the stack display mode, the appended information being appended to the image displayed in the overlap region.
